(19) United States
(12) Patent Application Publication
(10) Pub. No.: US 2021/0206110 A1
(43) Pub. Date: Jul. 8, 2021

(54) IDENTIFYING AN AC MAINS CONNECTION STATE OF A POWER DEVICE

(71) Applicant: HEWLETT-PACKARD DEVELOPMENT COMPANY, L.P., Spring, TX (US)

(72) Inventor: David E. SMITH, Vancouver, WA (US)

(73) Assignee: HEWLETT-PACKARD DEVELOPMENT COMPANY, L.P., Houston, TX (US)

(21) Appl. No.: 16/075,489

(22) PCT Filed: Apr. 25, 2017
(86) PCT No.: PCT/US2017/029396

§ 371 Date: Aug. 3, 2018

(51) Int. Cl. B29C 64/393; B33Y 30/00; B33Y 50/02; H02J 3/00

(52) U.S. Cl. CPC B29C 64/393; H02J 3/00; B33Y 50/02; B33Y 30/00

(57) ABSTRACT

A system to identify an AC mains connection state of a power device comprising a monitoring device connected to a plurality of different AC mains power inputs of the power device, wherein the monitoring device monitors an electrical parameter at the respective AC mains power inputs; and a controller to monitor a difference between electrical parameter values at the plurality of AC mains power inputs, wherein the controller determines a connection state of the power device from the difference between the electrical parameter values.

### BACKGROUND

Power devices may comprise a large load connected to a power supply circuit that may consume a large electrical power. Hence, there is a demand for adapted power supply circuitry for supplying this large electrical power.

### BRIEF DESCRIPTION OF THE DRAWINGS

The following detailed description will best be understood with reference to the drawings, wherein:

FIG. 1 illustrates a system to identify an AC mains connection state of a power device according to an example.

FIG. 2 illustrates a system to identify an AC mains connection state of a power device according to another example.

FIGS. 3a, 3b illustrate circuit configurations of different AC mains connection states of a power device according to two examples.

FIG. 4 illustrates a schematic of a 3-D printer according to an example.

FIG. 5 illustrates a flow diagram of a method for identifying an AC mains connection state of a power device according to an example.

FIG. 6 illustrates a flow diagram of a method for identifying an AC mains connection state of a power device according to another example.

### DETAILED DESCRIPTION

High-power devices, such as 3-D printers, can draw a large current from an AC mains power supply during operation. This current can be larger than a standard current rating of AC mains circuitry, such as 15 A. By connecting a single high-power device to a plurality of AC mains power sockets, the load can be distributed over separate AC mains circuits. However, the high-power device may accidentally be connected to multiple outlets of the same AC mains circuit, such as a duplex outlet. In this case, the load cannot be correctly distributed and may result in a high current exceeding a limited maximum current rating, which can lead to power failure or even a safety hazard.

To address these issues, in the examples described herein, a system and method for identifying an AC mains connection state of the power device is provided.

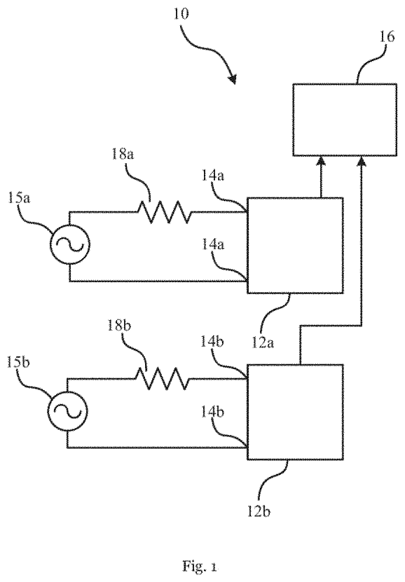

FIG. 1 shows one example of a system 10 to identify an AC mains connection state of the power device comprising a plurality of monitoring devices, such as two monitoring devices, 12a, 12b and a controller 16, each monitoring device connected to a different AC mains power input 14a, 14b of a plurality of AC mains power inputs 14a, 14b of the power device.

According to another example, instead of a plurality of monitoring devices, a single monitoring device (not shown) can be provided which is connected to at least two AC mains power inputs 14a, 14b. According to a further example, the plurality of monitoring devices 12a, 12b can be considered to be parts of a single monitoring apparatus. Hence, the system 10 to identify an AC mains connection state of the power device may comprise a monitoring device wherein the monitoring device is connected to one, some or all of the plurality of AC mains power inputs 14a, 14b of the power device, and a controller 16. Whereas, in the following, reference is made to a plurality of monitoring devices 12a, 12b, such as to monitoring devices, the system may also be implemented with a single monitoring device.

In FIG. 1, the AC mains power inputs 14a, 14b are electrically connected to AC voltage sources 15a, 15b. This representation illustrates an example of an input configuration of the system 10 that is to be connected to an AC mains power source, such as a wall socket (output) of an AC mains circuit, a generator output, an output of an uninterruptible power supply, or other suitable sources of AC mains power.

Moreover, the AC voltage sources 15a, 15b may not be different voltage sources and may be representations of connections to a single common voltage source. In some examples, the AC voltage sources 15a, 15b may be electrical connections to a common AC mains circuit acting as the AC mains power source of the power device.

The AC mains power inputs 14a, 14b may be considered to comprise at least two physical electrical inputs suitable to conduct electrical alternating current from the AC voltage source 15a, 15b to the power device (not shown in FIG. 1). The AC voltage source 15a, 15b may be an AC mains circuit with a voltage rating such as 220 V, 230 V, or 120 V, or a voltage of an industrial AC power connection, such as between 100 V and 690V, or any other AC or DC voltage of any other suitable electrical power supply circuit.

In the following, a flow of electrical energy (current) is assumed from the AC voltage sources 15a, 15b towards the AC mains power inputs 14a, 14b, and the location of components may accordingly be specified in terms of the power flow direction, such as upstream or downstream.

The plurality of monitoring devices 12a, 12b monitor an electrical parameter at the respective AC mains power input 14a, 14b.

The electrical parameter may be a voltage, a current, an electric field, a magnetic field, combinations of these or the like. The electrical parameter may furthermore be monitored as a function of time, wherein the electrical parameter is measured and stored at points in time that may be equally spaced or depend on the internal or external trigger condition.

The controller 16 of the system 10 may be a microcontroller, an ASIC, a PLA (CPLA), a FPGA, or other control device, including control devices operating based on software, hardware, firmware, or a combination thereof. The controller 16 can include an integrated memory, or communicate with an external memory, or both and may further comprise terminals to be connected to sensors, devices, appliances, integrated logic circuits, other controllers, or the like, wherein the terminals may be configured to receive or send signals, such as electrical signals, optical signals, wireless signals, acoustic signals, or the like.

The controller 16 monitors a difference between electrical parameter values at least two of AC mains power inputs 14a, 14b, e.g. at a pair of AC mains power inputs 14a, 14b.

The electrical parameter value may be derived from the electrical parameter that is monitored by the monitoring devices 12a, 12b. Monitoring the difference between electrical parameter values may thereby comprise receiving information on the electrical parameter from the monitoring devices 12a, 12b. To determine the difference between electrical parameter values, the controller 16 may also first determine individual electrical parameter values before the difference is determined.

The electrical parameter value may comprise voltage data, current data, electrical field data, a magnetic field data, resistance data, conductivity data, power data, phase data, combinations of these or other electrical parameter values. The controller 16 may calibrate the system to compensate for systematic differences between the electrical parameter values at the power inputs 14a, 14b, and the controller 16 may further calculate an average the difference of the electrical parameter values over a plurality of the electrical parameter values or perform another type of preprocessing of a plurality of electrical parameter values.

From the difference between the electrical parameter values, the controller 16 determines a connection state of the power device.

Examples of connection states may be a duplex connection and a non-duplex connection state that indicate if the power device is connected to a duplex outlet or a similar outlet that share electrical connections with a limited current rating, or if the power device is connected to separate AC mains circuits (non-duplex). The separate AC mains circuits, or non-duplex circuits, which also can be considered as independent portions of the AC mains circuit, may relate to separate electrical connections that allow distributing an AC mains electrical power over a number of electrical circuitries wherein the electrical power is supplied through a number of high-power conductors of the AC mains circuit, or separate AC mains circuits may relate to electrical connections connected to separate fuses of the AC mains circuit.

FIG. 1 further illustrates that the electrical connection upstream of the AC mains power inputs 14a, 14b to an AC voltage source 15a, 15b is associated with finite electrical resistances 18a, 18b.

The resistance 18a, 18b may be considered to comprise a resistance of the independent portions of the AC mains circuit upstream of the AC mains power inputs 14a, 14b, and may include a resistance of a power cord, resistances of electrical connections, a resistance of the AC mains circuit, such as a wiring of the AC mains circuit, or the like. Moreover, the resistance 18a, 18b can be related to a length and a diameter of the wiring of the AC main circuitry. The value of the resistances 18a, 18b may be used to identify the connection state.

For example, to determine the connection state, e.g. whether a duplex or non-duplex connection state, the electrical parameter, monitored by the monitoring devices 12a, 12b, may be a voltage and the difference between the electrical parameter values may be a voltage difference. The voltage difference may be a function of a current drawn by loads of the power device (not shown in FIG. 1) and the resistance 18a, 18b. By monitoring the voltage difference between separate AC mains power inputs 14a, 14b of the high-power device connected to the plurality of power outlets, as a function of different loads (e.g. expressed as current and/or voltage) drawn from each of the AC mains power inputs 14a, 14b, the resistance 18a, 18b of the independent portion of the AC mains circuit connection may be determined. A resistance threshold value may then allow differentiating between a situation of electrical connections to separate AC mains circuits (non-duplex) and a situation, where the high-power device is connected to multiple outlets of the same AC mains circuit (duplex).

The controller 16 can thereby determine a connection state of the power device by evaluating resistance 18a, 18b values of the AC mains power circuit based on the voltage difference and comparing the resistance 18a, 18b values to a resistance threshold value.

However, the controller 16 may also determine a duplex or non-duplex connection state based on a different type of electrical parameter, such as a nonlinearity of a current to voltage relationship or other derived indicators based on the electrical parameters.

Furthermore, the controller 16 may also determine different connection states, such as an in-phase/out-of-phase connection state that may be based on other types of electrical parameter values, such as the phases of an electrical signal measured by the monitoring devices 12a, 12b, or the like.

In some examples, the controller 16 may also separately determine values of the resistances 18a, 18b of the independent portions of the AC mains power circuit from the electrical parameters associated with the respective AC mains power inputs 14a, 14b to determine the connection state, such as determining the resistance 18a, 18b from a combination of voltage and current data acquired by the respective monitoring device 12a, 12b and determining the connection state of the power device from a difference of the resistances 18a, 18b.

In one example, when the controller 16 determines that the difference between the electrical parameter values exceeds a threshold value, the controller 16 generates an abnormal connection state signal.

The abnormal connection state signal may be sent via a terminal of the controller 16 to another controller, an ASIC, an interconnecting device, a telecommunication link, or the like, or may generate an audiovisual signal in proximity to the system 10, such as a light signal or an audible signal, or may induce the display of an error signal at an interface of the system 10, the power device, a distant monitoring unit, or the like. The abnormal connection state signal may further comprise information for a service technician.

The threshold value may (dynamically) depend on an electrical load of the power device, or may be specified by a standard, such as a safety standard or a norm, or may depend on a calibration of the power device, the AC mains circuit, a wire connection, or the like. For example, in the case of a duplex/non-duplex connection state, the threshold value may depend on a wire gauge, a wire length of power device connectors, or an electrical building standard of an AC mains circuit wiring.

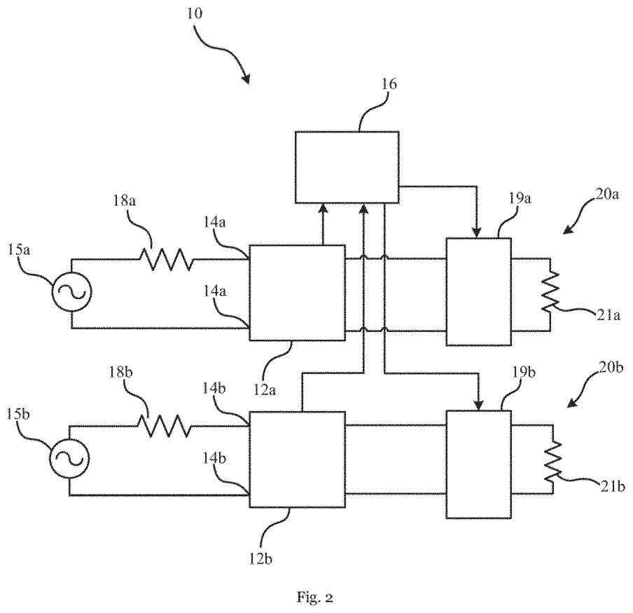

In an example illustrated in FIG. 2, the controller 16 further controls at least one load 20a, 20b connected to at least one of the AC mains power inputs 14a, 14b, wherein the load 20a, 20b may be located downstream of the AC mains power inputs 14a, 14b.

When the controller 16 controls at least one of the loads 20a, 20b, the controller 16 may cause a difference of the electrical current and/or voltage at the AC mains power inputs 14a, 14b and thereby deterministically induce the difference of the electrical parameter values used to determine the connection state of the power device, such as a voltage difference.

In FIG. 2, the loads 20a, 20b each are depicted as comprising a power unit, such as a power supply 19a,19b connected to a resistor 21a, 21b; however, any load 20a, 20b that draws electrical power from the AC mains power inputs 14a, 14b may be used. Examples for the loads 20a, 20b may comprise a resistor, a power device, a part of a power device, a power supply, a power converter, a heater, or any other electrical appliance. The loads 20a, 20b can also comprise a high-power load, such as a high-power heating device. Just as an example, the high-power heating device may be an infra-red lamp, a tungsten lamp, a filament based heating device, a thermal based curing device or any other heating device. The loads 20a, 20b can further be a high-power load operating on an AC power supply that may have a frequency of 50 or 60 Hz. The loads 20a, 20b may also have a high electrical power consumption, such as a power consumption higher than 1 kW or a power consumption in the range of 1 kW to 100 kW, or 2 kW to 50 kW, or 4 kW to 20 kW, to just give some examples, and the power consumption may temporarily be lower or higher.

As shown in the example of FIG. 2, the load 20a, 20b may comprise the power supply 19a, 19b to control the electrical power of the load 20a, 20b, such as a power converter. The power converter may be a (mains) power supply, an inverter, a converter, a regulator, a transformer, a rectifier, or any other suitable device for controlling and/or converting electrical power that is supplied to the load 20a, 20b.

Referring still to FIG. 2, the system 10 may establish a detection mode, wherein the controller 16 provides a different electrical load to each of the AC mains power inputs 14a, 14b of the pair of AC mains power inputs 14a, 14b to determine the connection state of the power device.

For example, in the detection mode, the controller 16 may cause a first current at a first power input 14a and a second current at a second power input 14b by controlling the loads 20a, 20b connected to the respective power inputs. This may induce a voltage difference at the AC mains power inputs 14a, 14b that depends on the resistance 18a, 18b of the independent portion of the AC mains circuits connecting the AC mains power inputs 14a, 14b to a common portion of the AC mains circuit. By determining the resistance 18a, 18b of the independent portion of the AC mains circuit from the voltage difference, and comparing the value to a threshold value of the circuit resistance, the connection state of the power device can be determined.

To connect the power device to the AC mains power source, the AC mains power inputs 14a, 14b may include connectors to be connected to separate sockets of an AC mains circuit.

The connectors may be connectable to standard power connectors and comprise a finite wire length that may contribute a finite series resistance to the resistance 18a, 18b of the independent portion of the AC mains circuit. The accuracy of the system 10 may be increased determining the threshold parameter so that it is dependent on a predetermined, calibrated, or externally supplied value for the finite series resistance of the connectors of the system 10.

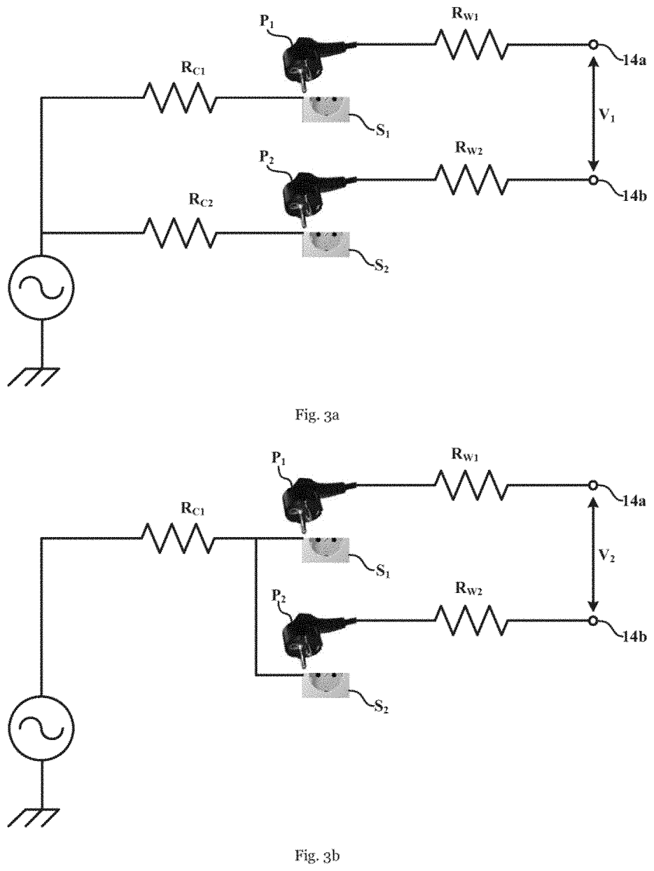

Two examples of electrical connection configurations in a non-duplex and a duplex connection state are illustrated in FIG. 3a and FIG. 3b, respectively. In FIG. 3a, an AC power source is connected via two separate parallel circuits having resistance R_{C1} and resistance R_{C2} to two sockets S₁ and S₂. Plugs P₁ and P₂ connect the AC mains power inputs 14a, 14b of the power device to the sockets S₁ and S₂ using power cords (wires) having resistance R_{W1} and R_{W2}, respectively. When different electrical currents are drawn at the AC mains power inputs 14a, 14b of the power device, a voltage difference V₁ develops that depends on the sums of the resistances R_{C1}+R_{W1} and R_{C2}+R_{W2}. The sum of the resistances may be comprised in the resistances 18a, 18b upstream of the AC mains power inputs 14a, 14b.

For example, when a current I₁ is drawn by the first load 20a and a current I₂ is drawn by the second load 20b, the voltage difference V₁ may be established according to

V₁=I₁*(R_{C1}+R_{W1})−I₂·(R_{C2}+R_{W2}). (1)

In the case of a duplex connection illustrated in FIG. 3b, the sockets S₁ and S₂ are connected to the AC power source through essentially the same electrical connection having the resistance R_{C1}. Now, when different electrical currents are drawn from the AC mains power inputs 14a, 14b of the power device, the voltage difference V₂ between the AC mains power inputs 14a, 14b may depend on just the resistances R_{W1} and R_{W2}.

For example, when again a current I₁ is drawn by the first load 20a and a current I₂ is drawn by the second load 20b, the voltage difference V₂ may be established according to

V₂=I₁*R_{W1}−I₂·R_{W2}. (2)

Therefore, in the duplex connection state, a lower voltage V₂ may be measured than in the non-duplex connection state. As the values of the voltages V₁ and V₂ may be different, the connection state can be identified.

For example, the power device may be connected to the socket S₁, S₂ with a 12 American wire gauge (AWG), 2 m long cord. The socket S₁, S₂ is connected to a common AC mains source circuit with a 10 m long 12 AWG copper wire, wherein the AC mains source circuit supplies a voltage of 230 V RMS (root mean square) at a frequency of 50 Hz. A current I₁ of 20 A is drawn from one of the AC mains power inputs 14a, and a current I₂ of 1 A is drawn from another AC mains power input 14b. In the non-duplex connection state, a voltage difference V₁ of 2.35 V RMS may be measured between the AC mains power inputs 14a, 14b. In the duplex connection state, a voltage difference V₂ of 0.39 V RMS may be measured between the AC mains power inputs 14a, 14b. The connection state may therefore be identified.

As an example, for the case of 12 AWG wire (with a characteristic resistance of 2*5.21 mΩ/m) used within the AC mains circuit wiring, a current I₁ of 20 A drawn by the first load 20a and a current I₂ of 1 A drawn by the second load 20b, the difference V₁−V₂ may also be specified as a function of the (equal) length of the independent AC mains circuit wiring:

| circuit wire length | circuit resistance R_{C1}(R_{C2}) | |
|---|---|---|
| (m) | (Ω) | difference V₁-V₂ (V) |
| 0 | 0.000 | 0.00 |
| 5 | 0.052 | 0.99 |
| 10 | 0.104 | 1.98 |
| 15 | 0.156 | 2.97 |
| 20 | 0.208 | 3.96 |
| 25 | 0.261 | 4.95 |

The voltage difference or circuit resistance (i.e. resistance of the independent portion of the AC mains circuit) may therefore be detected and related to a connection state of the power device.

In some examples, the controller 16 may sequentially drive each of the loads 20a, 20b at different electrical power. For example, the controller 16 may first monitor the electrical parameter at each of the AC mains power inputs 14a, 14b for a higher electrical current and/or voltage drawn by the first load 20a and a lower electrical current and/or voltage drawn by the second load 20b. Then, the controller 16 may monitor the electrical parameter at each of the AC mains power inputs 14a, 14b for a lower electrical current and/or voltage drawn by the first load 20a and a higher electrical current and/or voltage drawn by the second load 20b. Based on the measurements of the electrical parameter, the controller 16 may determine (different) values of a first sum of resistances 18a, R_{C1}+R_{W1} and a second sum of resistances 18b, R_{C2}+R_{W2}. A difference of the sums of resistances 18a, 18b may then be related to the connection state of the power device.

For example, if the sums of the resistances 18a, 18b upstream of the respective AC mains power inputs 14a, 14b differ by a value that is larger than a predetermined (resistance variation) threshold, the controller 16 may assert a non-duplex connection state.

The difference of the sums of resistances 18a, 18b may also be determined based on equal currents at the two loads 20a, 20b and monitoring the voltage difference at the respective AC mains power inputs 14a, 14b.

In some examples, the system 10 is embedded in the power device, or in a high-power device, such as a 3-D printer. 3-D printers generate a three-dimensional object based on a three-dimensional design using a 3-D build material.

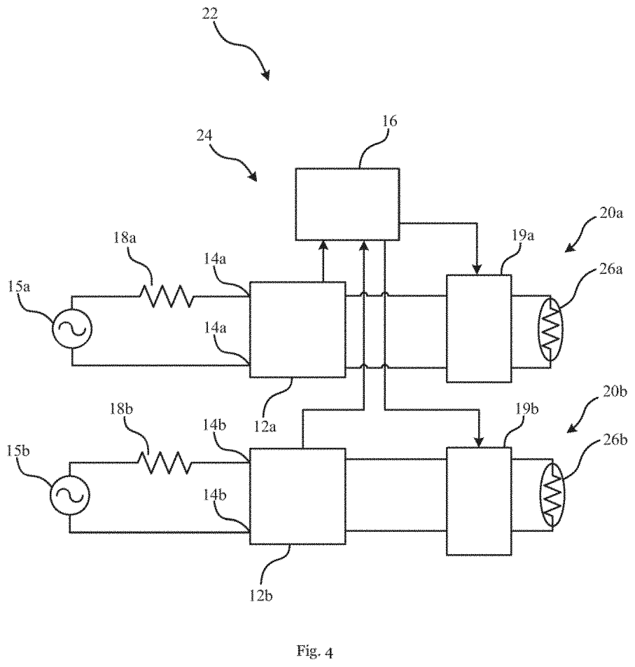

An example of a 3-D printer 22 is illustrated in FIG. 4 and comprises a power supply circuit 24, a controller 16, and a number of heaters 26a, 26b. The power supply circuit 24 comprises at least one voltage monitoring device 12a, 12b connected to an AC mains power input 14a, 14b of a plurality of AC mains power inputs 14a, 14b of the 3-D printer 22. In the example of FIG. 4, two voltage monitoring devices 12a, 12b are provided which monitor a voltage at the respective AC mains power input 14a, 14b. Furthermore, the power supply circuit 24 may comprise loads 20a, 20b, wherein the heaters 26a, 26b may be part of the loads 20a, 20b.

The heater 26a, 26b may be used to change the temperature of a substrate that is printed on or the temperature of a 3-D built material used for printing. Such a material may be a thermoplastic, a metal or a curable resist, resin, or plaster, although any suitable material for 3-D printing may be used. The heater 26a, 26b may be an infra-red lamp, a filament based heating device, a thermal based curing device or any other heating device. For example, the heater 26a, 26b may comprise a tungsten lamp. However, the heater 26a, 26b may also be a high-power light source, such as a laser, used for sintering, melting, or fusing a metal powder. In the case that the material is a curable resist, resin, or plaster, the heater 26a, 26b may be replaced with a light source used to locally excite and thereby cure the material.

The controller 16 receives the voltages from the plurality of voltage monitoring devices 12a, 12b, monitors a voltage difference between voltages at different AC mains power inputs 14a, 14b of at least two AC mains power inputs 14a, 14b, controls a load 20a, 20b on each one of the at least two AC mains power inputs 14a, 14b and also controls the heater 26a, 26b. From the voltage difference, the controller 16 determines a connection state of the 3-D printer 22.

The loads 20a, 20b of the 3-D printer 22 may comprise loads 20a, 20b as referred to with reference to the system 10, but may also comprise a plurality of power supplies 19a, 19b each connected to a heater 26a, 26b as shown in FIG. 4. On the other hand, the loads 20a, 20b may also refer to a plurality of power supplies 19a, 19b that supply power to a number of heaters 26a, 26b that may be different from the number of power supplies 19a, 19b of the 3-D printer 22.

The determination of the connection state of the 3-D printer 22 may be similar to the determination of the connection state of the system 10 for identifying an AC mains connection state, and similar operations may be performed by the controller 16.

For example, during a detection mode of the 3-D printer 22, the controller 16 may provide different electrical current 20a, 20b to different AC mains power inputs 14a, 14b of the at least two AC mains power inputs 14a, 14b to determine the connection state of the power device.

To that end, the controller 16 may change an electrical power of a heater 26a, 26b of the 3-D printer 22 that is connected to either of the AC mains power supply inputs 14a, 14b.

In addition, the controller 16 may also acquire current data associated with AC mains power inputs 14a, 14b to determine the connection state of the 3-D printer 22. In this case, the 3-D printer may comprise a current monitoring device to acquire current data, or the controller may acquire current data from the respective load 20a, 20b.

The 3-D printer 22 may further comprise any additional system components, or system configurations, or component configurations of the system 10 to identify an AC mains connection state of a power device described above.

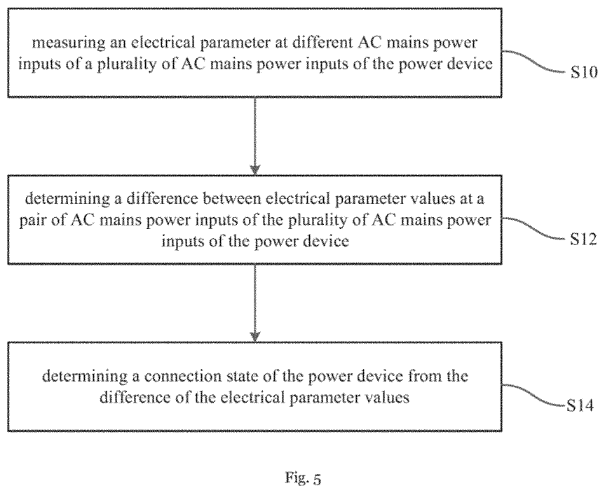

In one example illustrated in FIG. 5, a process for identifying an AC mains connection state of a power device is provided. The process comprises measuring S10 an electrical parameter at different AC mains power inputs 14a, 14b of a plurality of AC mains power inputs 14a, 14b of the power device, determining S12 a difference between electrical parameter values at least two AC mains power inputs 14a, 14b of the plurality of AC mains power inputs 14a, 14b of the power device, and determining S14 a connection state of the power device from the difference of the electrical parameter values. The order of the instructions is hereby and in the following not considered to impose any temporal order that they have to be performed in. For example, the instructions may be performed simultaneously, or in any suitable order.

In this and further examples, the electrical parameter may be a voltage and the difference of the electrical parameter values may be a voltage difference. In this case, the method may additionally comprise generating an abnormal connection state signal, when the voltage difference exceeds a threshold value.

In a further example, the method may additionally comprise controlling at least one load 20a, 20b connected to at least one of the AC mains power inputs 14a, 14b.

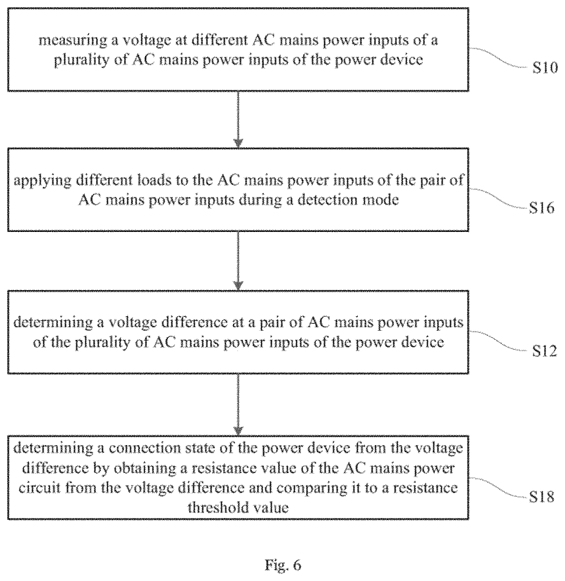

As illustrated in FIG. 6, examples of the method may additionally comprise applying S16 different loads 20a, 20b to the AC mains power inputs 14a, 14b of the at least two AC mains power inputs 14a, 14b during a detection mode to determine the connection state of the power device.

In some examples, the method may additionally comprise determining S18 a connection state of the power device from the voltage difference by obtaining a value of the resistance 18a, 18b of the AC mains power circuit from the voltage difference and comparing the value of the resistance 18a, 18b to a resistance threshold value.

Additionally, the method for identifying an AC mains connection state of a power device may also implement additional instructions for controlling and monitoring the systems or power devices described above or may comprise instructions implementing the functionality of components of the systems or power devices described above.

What is claimed:

1. A system to identify an AC mains connection state of a power device comprising:
a monitoring apparatus connected to at least two different AC mains power inputs of a plurality of AC mains power inputs of the power device,
wherein the monitoring apparatus monitors an electrical parameter at the respective AC mains power inputs; and
a controller to monitor a difference between electrical parameter values at the at least two AC mains power inputs,
wherein the controller determines a connection state of the power device from the difference between the electrical parameter values.

2. The system of claim 1, wherein the electrical parameter is a voltage and the difference between the electrical parameter values is a voltage difference.

3. The system of claim 1, wherein, when the controller determines that the difference between the electrical parameter values exceeds a threshold value, the controller generates an abnormal connection state signal.

4. The system of claim 1, wherein the controller further controls at least one load connected to at least one of the AC mains power inputs.

5. The system of claim 4, wherein the controller, during a detection mode, further provides a different load to each of the AC mains power inputs of the at least two AC mains power inputs to determine the connection state of the power device.

6. The system of claim 1, wherein the AC mains power inputs include connectors to be connected to separate sockets of an AC mains circuit, and wherein the controller determines a duplex or non-duplex connection state of the power device.

7. The system of claim 2, wherein the controller determines a connection state of the power device by obtaining a resistance value of the AC mains power circuit from the voltage difference and compares the resistance value to a resistance threshold value.

8. A 3-D printer comprising:
a power supply circuit, a controller, and a heater,
the power supply circuit comprising a monitoring device connected to an AC mains power input of a plurality of AC mains power inputs of the 3-D printer to monitor a voltage at the respective AC mains power input; and
the controller receiving the voltages from the voltage monitoring device, monitoring a voltage difference between voltages at different AC mains power inputs of at least two AC mains power inputs, controlling a load on each one of the at least two of AC mains power inputs and controlling the heater;
wherein the controller determines a connection state of the 3-D printer from the voltage difference.

9. The 3-D printer of claim 8, wherein the controller, during a detection mode, further provides different loads to different AC mains power inputs of the at least two of AC mains power inputs to determine the connection state of the power device.

10. The 3-D printer of claim 8, further comprising a plurality of voltage monitoring devices, each connected to a different AC mains power input of the plurality of AC mains power inputs of the 3-D printer,
wherein the controller determines a duplex or non-duplex connection state of the 3-D printer.

11. A method for identifying an AC mains connection state of a power device comprising:
measuring an electrical parameter at different AC mains power inputs of a plurality of AC mains power inputs of the power device,
determining a difference between electrical parameter values at least two AC mains power inputs of the plurality of AC mains power inputs of the power device; and
determining a connection state of the power device from the difference of the electrical parameter values.

12. The method of claim 11, wherein the electrical parameter is a voltage and the difference of the electrical parameter values is a voltage difference.

13. The method of claim 12, further comprising:
generating an abnormal connection state signal, when the voltage difference exceeds a threshold value.

14. The method of claim 11, further comprising:
applying different loads to the AC mains power inputs of the at least two of AC mains power inputs during a detection mode to determine the connection state of the power device.

15. The method of claim 12, further comprising:
obtaining a resistance value of the AC mains power circuit from the voltage difference and
comparing the resistance value to a resistance threshold value, wherein the resistance threshold values allows determining a duplex or a non-duplex connection state.
